(19) United States
(12) Patent Application Publication
(10) Pub. No.: US 2026/0077476 A1
(43) Pub. Date: Mar. 19, 2026

(54) DUAL-PURPOSE GARAGE CREEPER

(71) Applicant: HIEVER CO., LTD., Taichung City (TW)

(72) Inventors: Tony HUANG, Taichung City (TW); Jeffery HUANG, Taichung City (TW)

(73) Assignee: HIEVER CO., LTD., Taichung City (TW)

(21) Appl. No.: 18/918,968

(22) Filed: Oct. 17, 2024

(30) Foreign Application Priority Data
Sep. 18, 2024 (TW) 113210129

(51) Int. Cl. B25H 5/00

(52) U.S. Cl. CPC B25H 5/00

(57) ABSTRACT

A dual-purpose garage creeper includes a frame and a platform. The frame is provided with four supporting legs. Each supporting leg is pivotally provided with a caster base that can be turned by 180 degrees with respect to the supporting leg. The platform is pivotally provided on the frame and can be turned by 180 degrees with respect to the frame. By inverting the caster bases and the platform, the height of the platform from the ground can be changed to adapt to a different scenario of use.

### BACKGROUND OF THE INVENTION

### 1. Technical Field

The present invention relates to a garage creeper for use in vehicle repair operations. More particularly, the invention relates to a dual-purpose garage creeper.

### 2. Description of Related Art

To make it easier for a mechanic to slide into and out of the space under the chassis of a vehicle, a garage creeper with casters such as those disclosed in USD634502 and USD566374 are generally used. This type of products is so designed that the body portion of each garage creeper is as low as possible to reduce the height of the entire structure, thereby allowing a mechanic to enter and exit the narrow space beneath a vehicle chassis while lying on a garage creeper. This design, however, provides each garage creeper with an invariable height and a single use, and each garage creeper cannot but be put away and left idle when not in use.

### BRIEF SUMMARY OF THE INVENTION

The primary objective of the present invention is to provide a dual-purpose garage creeper whose height and use can be changed.

To achieve the primary objective, the dual-purpose garage creeper of the present invention includes a frame, four caster bases, and a platform. The frame has an elongated shape and includes a pair of corresponding long lateral sides. One of the long lateral sides is provided with a fixing device, and the two ends of each long lateral side are each provided with a supporting leg. Each supporting leg has one end coupled to the corresponding long lateral side of the frame and an opposite end extending slantingly away from, and located on one side of, the frame. Each of the four caster bases is pivotally provided on one of the supporting legs. Each caster base includes a rotating portion that is pivotally provided on the corresponding supporting leg and that can be inverted with respect to the corresponding supporting leg. The platform has an elongated shape and is pivotally provided on the frame. The platform has two ends each provided with a pivot shaft. The platform is pivotally provided on the frame via the two pivot shafts and can be rotated about a rotation axis defined by the two pivot shafts.

Based on the foregoing structural design, the dual-purpose garage creeper of the present invention allows its entire structure to be inverted by inverting the caster bases and the platform. This, coupled with the design that all the supporting legs extend on the same side of the frame, makes it possible to change the height of the platform from the ground so that after changing the height of the platform, the garage creeper is suitable for use as a common chair as well. The invention, therefore, improves the aforementioned drawbacks of the conventional products.

### BRIEF DESCRIPTION OF THE SEVERAL VIEWS OF THE DRAWINGS

FIG. 1 is a perspective view of the present invention.

FIG. 2 is a top view of the present invention.

FIG. 3 is a front view of the present invention.

FIG. 4 is an enlarged view of a caster base in the present invention.

FIG. 5 is similar to FIG. 4 except that the caster base has been inverted.

FIG. 6 is a bottom view of the present invention after the caster bases are inverted.

FIG. 7 is a sectional view taken along line 7-7 in FIG. 6.

FIG. 8 is a sectional view taken along line 8-8 in FIG. 6.

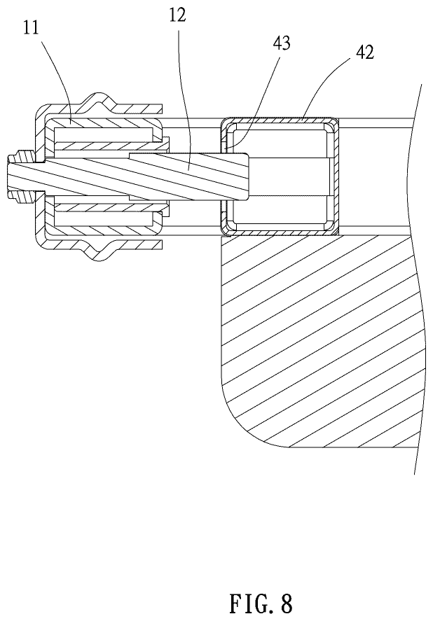

FIG. 9 is a front view of the present invention after the caster bases and the platform are inverted.

FIG. 10 is a front view of the present invention after the caster bases and the platform are inverted and after the resulting structure is subsequently inverted as a whole.

FIG. 11 is a perspective view of the structure in FIG. 10.

### DETAILED DESCRIPTION OF THE INVENTION

To begin with, the applicant would like to point out that, throughout this specification, including the description of the following embodiment and the appended claims, all the directional terms refer to the directions shown in the accompanying drawings to facilitate description but are not limited to the directions shown in the drawings. Besides, in the embodiment described below and the drawings, identical or similar elements or structural features are indicated by the same reference numeral. The upward, downward, leftward, and rightward directions stated herein make reference to, but are not limited to, the directions in the drawings.

Referring to the drawings, the present invention provides a dual-purpose garage creeper that can be switched between a high-position state of use and a low-position state of use. The dual-purpose garage creeper of the invention includes a frame 10, four caster bases 30, and a platform 40.

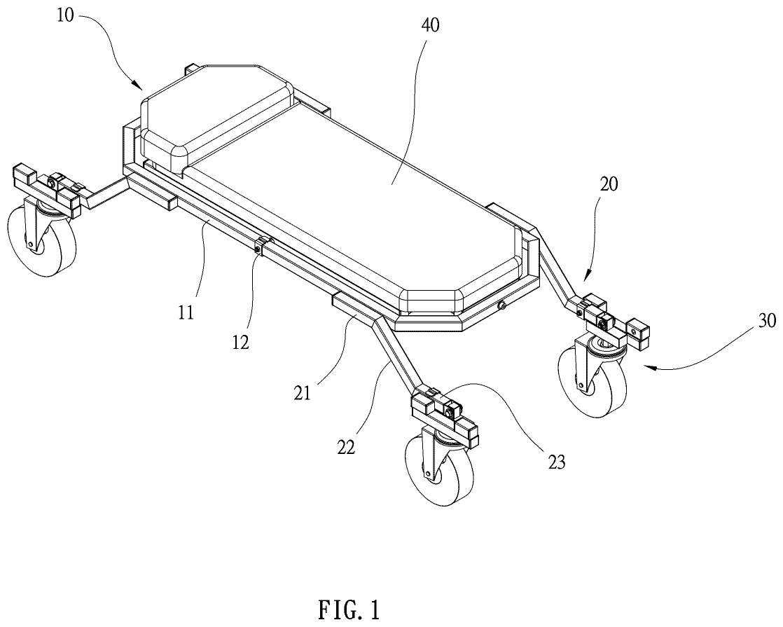

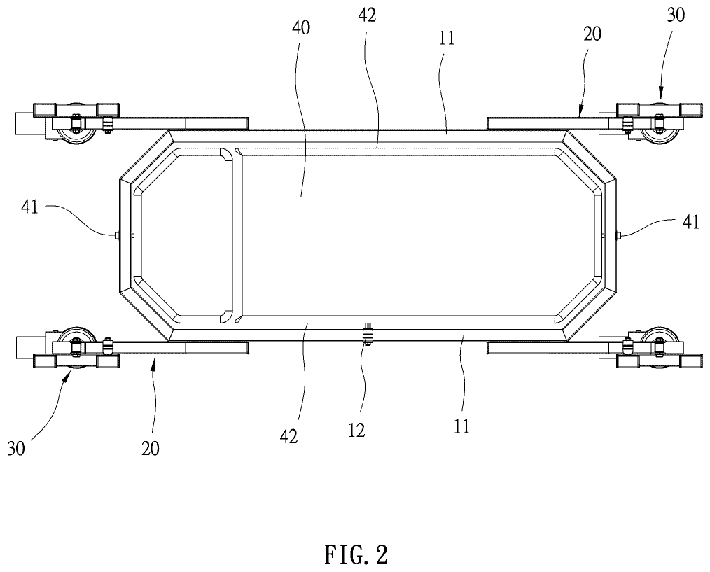

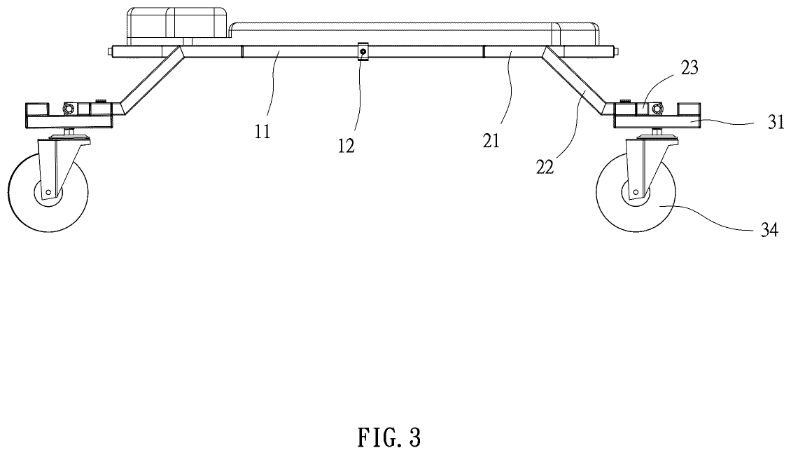

The frame 10 has an elongated shape. The frame 10 may be rectangular, hexagonal, octagonal, or of other shapes. In this embodiment, the frame 10 is an octagonal frame by way of example; the frame 10, however, is not limited to the octagonal frame illustrated herein. The frame 10 includes a pair of corresponding long lateral sides 11. One of the long lateral sides 11 is provided with a fixing device 12, and each of the long lateral sides 11 has two ends each provided with a supporting leg 20. Since all the supporting legs 20 are structurally identical, only one supporting leg 20 will be described below. The supporting leg 20 has a connecting section 21, a slanting section 22, and an extending section 23. The supporting leg 20 is coupled to the corresponding long lateral side 11 of the frame 10 via the connecting section 21. The slanting section 22 is connected to the connecting section 21, and the slanting section 22 extends slantingly away from the frame 10 and is located on one side of the frame 10. The extending section 23 is connected to the slanting section 22, and the extending section 23 is provided with a securing device 24. In this embodiment, the securing device 24 is a pin; the securing device 24, however, is not limited to a pin and may be, for example, a tenon or a bolt instead. The slanting extension of the slanting section 22 is such that the connecting section 21 and the extending section 23 are not at the same height, and that the plane in which all the extending sections 23 lie is different from the plane defined by the frame 10. In the high-position state of use as shown in FIG. 1 to FIG. 3, the extending section 23 is closer to the ground than are the connecting section 21 and the frame 10.

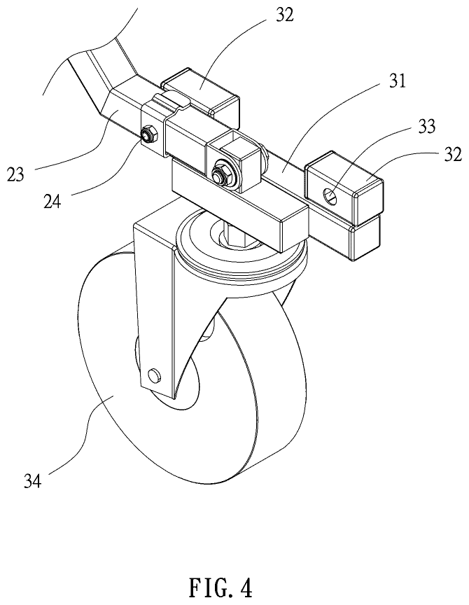

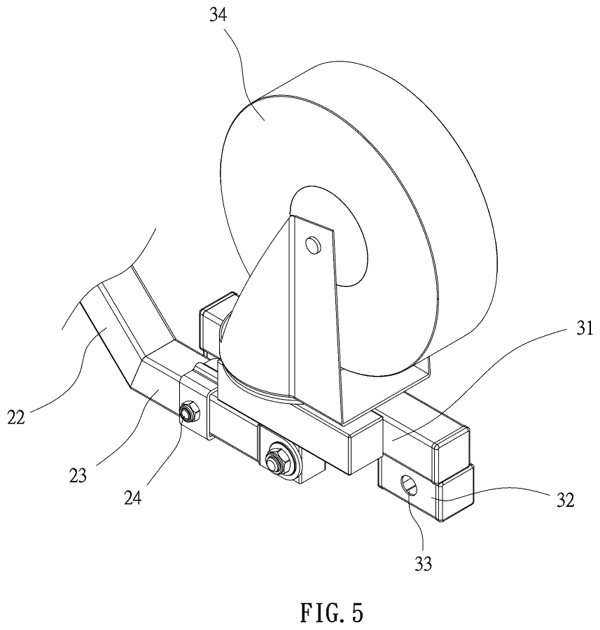

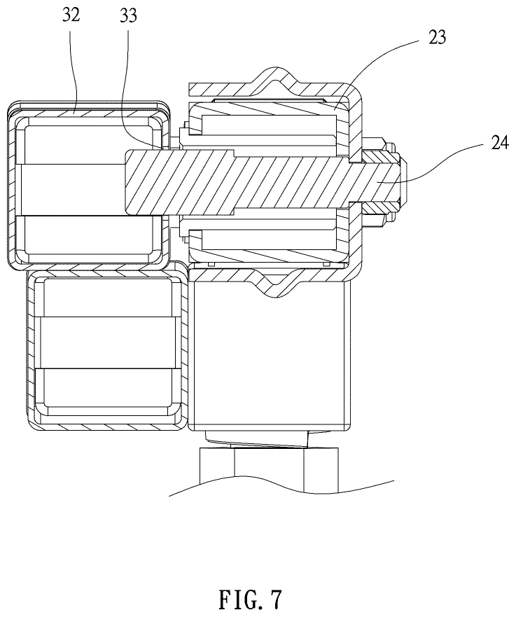

The four caster bases 30 are each pivotally provided on the extending section 23 of one of the supporting legs 20. As shown in FIG. 4, FIG. 5, and FIG. 7, each caster base 30 includes a rotating portion 31 that is pivotally provided on the corresponding extending section 23 and can be inverted, i.e., turned by 180 degrees, with respect to the corresponding extending section 23. Each rotating portion 31 is provided with two protruding blocks 32, and each protruding block 32 is provided with an engaging hole 33. Each engaging hole 33 corresponds in position to the securing device 24 on the corresponding extending section 23, e.g., a pin, so that the pin can be inserted into, and thereby fixed in, the engaging hole 33. A caster 34 is provided on one side of each rotating portion 31.

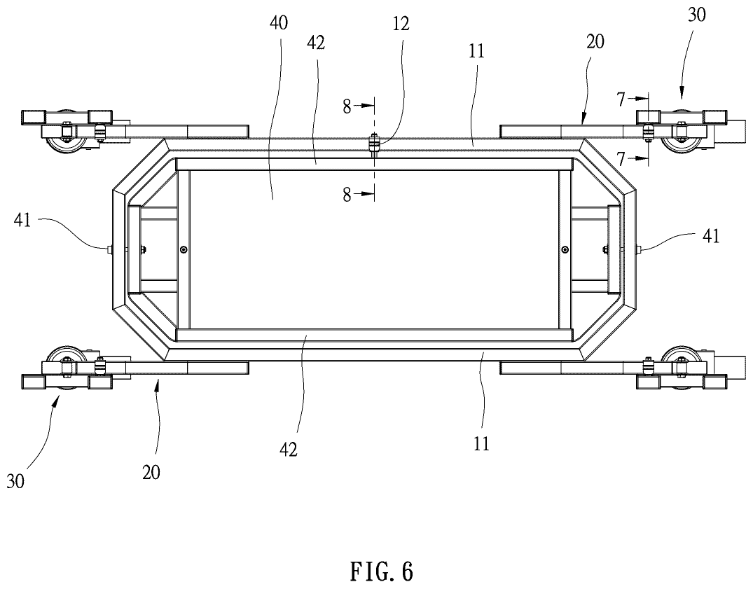

The platform 40 has an elongated shape and is pivotally provided on the frame 10. The platform 40 has two ends each provided with a pivot shaft 41. As shown in FIG. 6, the axis defined by connecting the two pivot shafts 41 is parallel to the major-axis direction of the frame 10, i.e., parallel to the extending direction of the long lateral sides 11. The platform 40 is pivotally provided on the frame 10 via the two pivot shafts 41 and can be rotated about a rotation axis defined by the two pivot shafts 41. The two opposite long lateral sides 42 of the platform 40 are each provided with an engaging hole 43, and the fixing device 12 on the aforesaid one of the long lateral sides 11 of the frame 10 in this embodiment is a pin that can be engaged in the engaging hole 43 in either of the long lateral sides 42 of the platform 40.

The foregoing structures are so designed that when the garage creeper of the present invention is in the high-position state of use as shown in FIG. 1 to FIG. 3, the supporting legs 40 extend downward, and the casters 34 are at positions far away from the platform 40. The platform 40 in this state is relatively high with respect to the ground, so the garage creeper can be used as a common chair or a working chair.

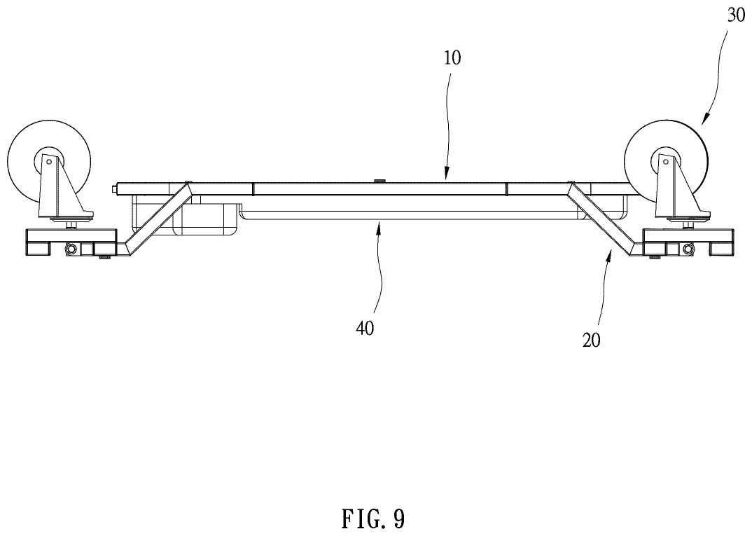

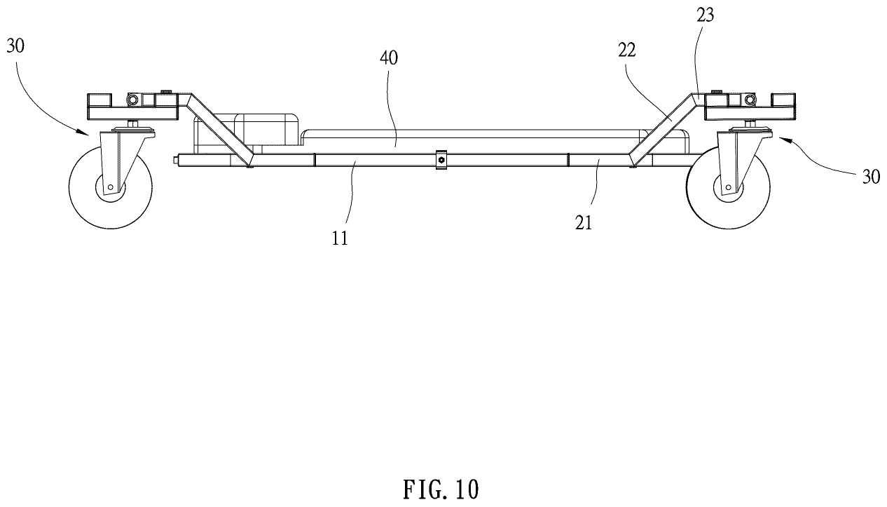

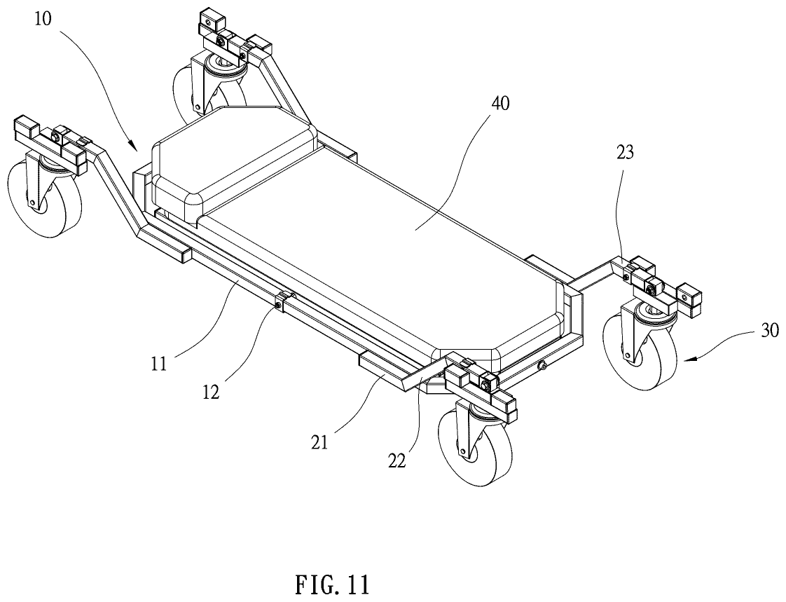

To convert the garage creeper from the chair configuration into a garage creeper configuration, the first step is to bring each securing device 24 out of engagement with the corresponding extending sections 23, then turn the four caster bases 30 by 180 degrees, and then bring each securing device 24 into engagement with the engaging hole 33 in the other protruding block 32 of the corresponding rotating portion 31, as shown in FIG. 5. After that, the fixing device 12 on the aforesaid one of the long lateral sides 11 of the frame 10 is brought out of engagement, and the platform 40 is subsequently inverted, i.e., turned by 180 degrees, as shown in FIG. 9. Lastly, the entire structure is turned by 180 degrees such that the casters 34 face downward and are put on the ground, as shown in FIG. 10 and FIG. 11. The height of the platform 40 is thus lowered, and the garage creeper is converted from the high-position state of use to the low-position state of use.

The structure of the present invention makes it possible to convert a working chair into a garage creeper, and vice versa, within a very short time and with a simple operation, and the objective of the invention is thereby achieved. In addition, to facilitate the inverting operation, the headrest on the platform may be fixed in place by hook-and-loop fasteners, which allow the headrest to be removed before the platform is inverted and put back in place after the platform is inverted.

What is claimed is:

1. A dual-purpose garage creeper, comprising:
a frame having an elongated shape and comprising a pair of corresponding long lateral sides, wherein one of the long lateral sides is provided with a fixing device, each of the long lateral sides has two ends each provided with a supporting leg, and each said supporting leg has one end coupled to a corresponding said long lateral side of the frame and an opposite end extending slantingly away from, and located on one side of, the frame and provided with a securing device;
four caster bases each pivotally provided on one of the supporting legs, wherein each said caster base comprises a rotating portion and a caster provided on one side of the rotating portion, each said rotating portion is pivotally provided on, and is able to be inverted with respect to, a corresponding said supporting leg, each said rotating portion is provided with two protruding blocks, and each said protruding block is provided with an engaging hole; and
a platform having an elongated shape and pivotally provided on the frame, wherein the platform has two ends each provided with a pivot shaft, the platform is pivotally provided on the frame via the two pivot shafts and is rotatable about a rotation axis defined by the two pivot shafts, the platform has two opposite long lateral sides each provided with an engaging hole, and each said engaging hole is fixedly engageable with the fixing device on the one of the long lateral sides of the frame.

2. The dual-purpose garage creeper of claim 1, wherein each said supporting leg has a connecting section, a slanting section, and an extending section, the connecting section of each said supporting leg is coupled to the corresponding long lateral side of the frame, the slanting section of each said supporting leg is connected to the connecting section of the each said supporting leg and extends slantingly away from, and is located on the one side of, the frame, and the extending section of each said supporting leg is connected to the slanting section of the each said supporting leg and is provided with a said securing device.

3. The dual-purpose garage creeper of claim 2, wherein all the extending sections lie in a plane different from a plane defined by the frame.

4. The dual-purpose garage creeper of claim 2, wherein a line connecting the two pivot shafts defines an axis parallel to a major-axis direction of the frame, and the major-axis direction is defined by an extending direction of the long lateral sides of the frame.

5. The dual-purpose garage creeper of claim 4, wherein all the extending sections lie in a plane different from a plane defined by the frame.

6. The dual-purpose garage creeper of claim 1, wherein a line connecting the two pivot shafts defines an axis parallel to a major-axis direction of the frame, and the major-axis direction is defined by an extending direction of the long lateral sides of the frame.

7. The dual-purpose garage creeper of claim 2, wherein each said rotating portion is pivotally provided on, and is able to be turned by 180 degrees with respect to, the extending section of the corresponding supporting leg.

8. The dual-purpose garage creeper of claim 5, wherein each said rotating portion is pivotally provided on, and is able to be turned by 180 degrees with respect to, the extending section of the corresponding supporting leg.
